(19) United States
(12) Patent Application Publication
(10) Pub. No.: US 2026/0163988 A1
(43) Pub. Date: Jun. 11, 2026

(54) IMAGE FORMING APPARATUS AND PROGRAM

(71) Applicant: Masataka Fushimi, Shizuoka (JP)

(72) Inventor: Masataka Fushimi, Shizuoka (JP)

(73) Assignee: ETRIA Co., Ltd., Kanagawa (JP)

(21) Appl. No.: 19/403,911

(22) Filed: Nov. 30, 2025

(30) Foreign Application Priority Data
Dec. 11, 2024 (JP) 2024-217085

(51) Int. Cl. H04N 1/00

(52) U.S. Cl. CPC H04N 1/00514; H04N 1/00411; H04N 1/00482; H04N 1/00517; H04N 1/0097; H04N 2201/0094

(57) ABSTRACT

An image forming apparatus includes a memory storing a program; and a processor configured to execute the program stored in the memory to execute processing. The processing includes: displaying a setting screen including a plurality of setting items; receiving settings of the plurality of setting items; starting image forming processing with the settings of the plurality of setting items based on an operation of an execution key; after the image forming processing is started, receiving an operation for canceling the image forming processing; in a case where the settings are changed after the operation for canceling the image forming processing is received and the image forming processing is started with the changed settings, holding information on a setting item for which the setting before change has been changed; and highlighting a display corresponding to the changed setting item on the displayed setting screen.

### CROSS-REFERENCE TO RELATED APPLICATIONS

The present application claims priority under 35 U.S.C. § 119 to Japanese Patent Application No. 2024-217085, filed on Dec. 11, 2024. The contents of which are incorporated herein by reference in their entirety.

### BACKGROUND OF THE INVENTION

### Technical Field

Embodiments described herein relate to an image forming apparatus and a program.

### Related Art

Conventionally, when a user uses a multifunction peripheral (MFP) to make copies, the user sets setting items on a setting screen of the MFP main body, and presses an execution key to start copying after the settings have been completed. If the user presses the execution key while the settings on the setting screen are incorrect, a desired output cannot be obtained, and the operation may need to be repeated.

WO 2021/025000 A1 discloses an image forming apparatus that, when a user presses an execution key, determines whether each image included in a job is similar to a misprinted image due to erroneous user settings in the past, and displays a confirmation message in processing the corresponding image.

However, many setting items are provided on the setting screen of the MFP main body. Therefore, users sometimes make a mistake of forgetting to set some setting items and starting copying. Such a mistake may only be made once, but if the mistake is caused by a user always forgetting to set the same setting item, there is a problem that the user will forget to set the same setting item, and the mistake will continue.

### BRIEF DESCRIPTION OF THE DRAWINGS

FIG. 1 is a diagram illustrating an example of a hardware block configuration of an image forming apparatus according to an embodiment;

FIG. 2 is a diagram illustrating an example of a data configuration of user setting information;

FIG. 3 is a diagram illustrating an example of a functional block configuration of an MFP;

FIG. 4 is a diagram illustrating an example of a schematic procedure of processing of a CPU;

FIG. 5 is a diagram illustrating an example of a procedure of setting processing for user setting information;

FIG. 6 is a diagram illustrating an example of a processing procedure that highlights a setting item that a user has forgotten to set in the past;

FIG. 7 is a diagram illustrating an example of a display mode for a setting item on a setting screen;

FIG. 8 is a diagram illustrating a first modification of a display mode for a setting item;

FIG. 9 is a diagram illustrating a second modification of a display mode for a setting item; and

FIG. 10 is a diagram illustrating a third modification of a display mode for a setting item.

### DETAILED DESCRIPTION

An image forming apparatus according to an embodiment includes a memory and a processor. The memory stores a program. The processor is configured to execute the program stored in the memory to execute processing. The processing includes: displaying a setting screen including a plurality of setting items, receiving settings of the plurality of setting items, starting image forming processing with the settings of the plurality of setting items based on an operation of an execution key, after the image forming processing is started, receiving an operation for canceling the image forming processing, in a case where the settings are changed after the operation for canceling the image forming processing is received and the image forming processing is started with the changed settings, holding information on a setting item for which the setting before change has been changed, and highlighting a display corresponding to the changed setting item on the displayed setting screen.

An embodiment may provide an image forming apparatus and a program that are capable of reducing forgetting to set setting items.

An embodiment will be described in detail below with reference to the drawings.

Hereinafter, embodiments will be described in detail with reference to the drawings. Note that the present invention is not limited by the embodiments described below.

In the following, embodiments will be described using an MFP as an example. A multifunction peripheral (MFP) is an image forming apparatus equipped with a copy function, a scan function, and a FAX function. In the following, “copy” is an example of image forming processing. Note that the configuration of the image forming apparatus is not limited to a configuration equipped with a copy function, a scan function, and a FAX function. The image forming apparatus may be equipped with at least one function of performing image formation among a copy function, a scan function, and a FAX function. In addition, a copy function, a scan function, and a FAX function are examples, and may constitute another function for forming an image.

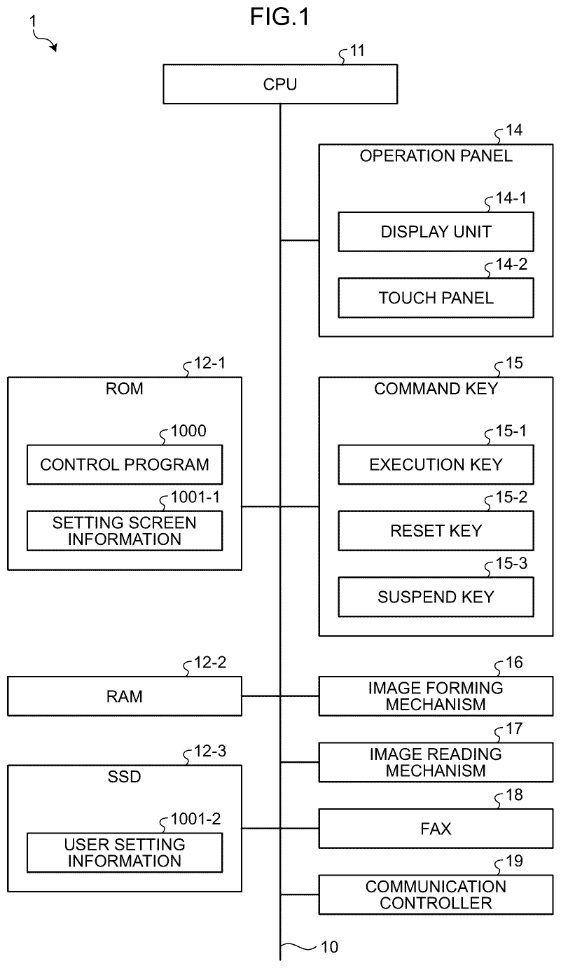

FIG. 1 is a diagram illustrating an example of a hardware block configuration of an image forming apparatus according to an embodiment. The hardware blocks illustrated in FIG. 1 are examples of hardware blocks of an MFP. The hardware blocks of an MFP 1 illustrated in FIG. 1 have a configuration in which a computer executes a program stored in a memory. As the configuration thereof, a central processing unit (CPU) 11, a read only memory (ROM) 12-1, a random access memory (RAM) 12-2, and a solid state drive (SSD) 12-3 are included. The CPU 11, the ROM 12-1, the RAM 12-2, and the SSD 12-3 are connected via a bus 10 so as to communicate with each other.

The CPU 11 executes a control program 1000 stored in the ROM 12-1 to control each unit of the MFP 1. The RAM 12-2 is used as a work space by the CPU 11. For example, the RAM 12-2 is used as a work space for temporarily storing data to be processed by the CPU 11.

The SSD 12-3 is an external storage device that holds update data. In addition to user setting information 1001-2, update data after editing setting screen information 1001-1 stored in the ROM 12-1 and the like are also output to the SSD 12-3 and held therein.

In addition, an operation panel 14, command keys 15, an image forming mechanism 16, an image reading mechanism 17, a FAX 18, a communication controller 19, and the like are connected to the bus 10.

The operation panel 14 is an operation panel provided in the main body of the MFP 1, and receives an operation by a user.

As an example, the operation panel 14 includes a display unit 14-1 and a touch panel 14-2. The display unit 14-1 is a display such as a liquid crystal, and displays a setting screen specified by the CPU 11 on the display. The touch panel 14-2 detects a user's touch position on the display. As the touch panel 14-2, a capacitive touch panel may be employed, an infrared touch panel may be employed, or a touch panel of another type may be employed.

The command keys 15 are button-type hardware keys, and a command is associated with each key. The command keys 15 are provided in the operation space of the main body of the MFP 1 together with the operation panel 14. Examples of the command keys 15 include an execution key 15-1, a reset key 15-2, and a suspend key 15-3.

Among the command keys 15, the reset key 15-2 and the suspend key 15-3 are examples of keys that instruct cancellation of processing, such as copying started in the main body of the MFP 1.

The image forming mechanism 16 forms an image on a sheet using an electrophotographic method. The image forming mechanism 16 creates, for example, a toner image of each CMYK and the like and transfers the created toner image to a fed sheet to form an image. The image forming mechanism 16 outputs the sheet on which the image has been formed to the post-processing apparatus side via a fixing unit and a drying unit, and accumulates the sheet in a sheet ejecting unit. The electrophotographic method is employed here, but the image forming mechanism 16 is not limited to the configuration of the electrophotographic method. Other methods, such as an inkjet method, may be adopted.

The sheet in the image forming mechanism 16 is fed from a sheet feeding tray. The sheet is fed from a tray selected based on the settings in the MFP 1 or a tray on which a target sheet is set.

Note that, although the configuration in which the MFP 1 includes the post-processing apparatus and the sheet feeding apparatus has been described, other processing apparatuses may be appropriately configured in the MFP 1.

The image reading mechanism 17 includes a reading sensor, such as a charge coupled device (CCD) or a complementary MOS (CMOS), and scans a reading target to read an image.

The FAX 18 is a controller for FAX transmission and reception that transmits and receives data, such as documents and images, to and from a set destination.

The communication controller 19 is a controller for transmitting and receiving data to and from a communication destination apparatus. The communication controller 19 performs communication via, for example, infrared communication such as IrDA, universal serial bus (USB), local area network (LAN), RS-232C, Bluetooth (registered trademark), or the like.

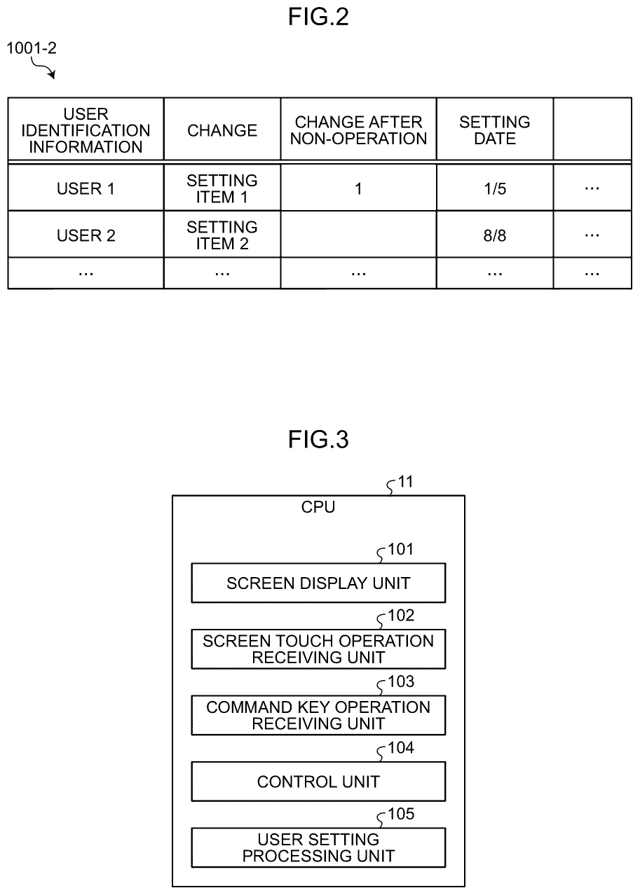

FIG. 2 is a diagram illustrating an example of a data configuration of the user setting information 1001-2. The user setting information 1001-2 stores data on “user identification information”, “change”, “change after non-operation”, and “setting date” in association with each other. The data on “user identification information”, “change”, “change after non-operation”, and “setting date” are set when the user performs an operation for canceling processing of the MFP 1 and a change from a first setting to a second setting, which will be described later.

In “user identification information”, user identification information on users who use the MFP 1 is set. User 1 and User 2 are user identification information assigned to two users.

In “change”, information on a setting item for which a setting has been changed is set. Specifically, in “change”, information on a setting item corresponding to a setting changed in the second setting from the first setting as a reference is set. The first setting corresponds to a setting when the processing is started with the execution key 15-1 (see FIG. 1). The second setting corresponds to a setting when the processing is started with the execution key 15-1, but is then canceled with the reset key 15-2 (see FIG. 1) or the suspend key 15-3 (see FIG. 1), and is started again with the execution key 15-1 after the setting has been changed. The first setting and the second setting are temporarily stored in the RAM 12-2 (see FIG. 1), and the comparison result thereof is set in “change”. Note that a “setting item 1” and a “setting item 2” illustrated in FIG. 2 are identification information corresponding to setting items included in the setting screen information 1001-1 (see FIG. 1). For example, the “setting item 1” is a “double-sided printing setting item” for setting whether to perform double-sided printing or single-sided printing. The “setting item 2” is a “color mode setting item” for setting full-color printing, monochrome printing, or the like. A plurality of setting items is not limited to these two, and includes many setting items such as a “number of copies setting item” for setting the number of copies, a “finishing setting item” for setting the finishing method, and a “stable setting item”. Since there are a wide variety of setting items, only some examples are given, and further description of types of setting items is omitted.

In “change after non-operation”, a flag “1” is set under the following condition. When a setting item set in “change” has not been operated before the processing is canceled, the flag “1” is set. Here, “non-operation” means that the setting item set in “change” is not touched on the setting screen before the processing has been canceled. For example, a case in which an initial value of the “setting item 1” is “single-sided printing” setting is described. When the “setting item 1” is not touched in the first setting but is touched in the second setting and the “single-sided printing” is changed to the “double-sided printing”, the flag “1” is set in “change after non-operation” in the “setting item 1”. In the setting, the CPU 11 detects the presence or absence of a touch operation on each setting item in the first setting and temporarily stores the result in the RAM 12-2 (see FIG. 1), and sets the flag “1” in “change after non-operation” when there is no touch operation.

In “setting date”, the date on which the setting item has been set in “change” is set. In FIGS. 2, 1/5 and 8/8 refer to January 5 and August 8, respectively.

Next, a functional block configuration of the image forming apparatus will be described. The CPU 11 of the MFP 1 illustrated in FIG. 1 executes the control program 1000 stored in the ROM 12-1 to perform functions as illustrated in FIG. 3 as examples.

FIG. 3 is a diagram illustrating an example of a functional block configuration of the MFP 1. As illustrated in FIG. 3, the CPU 11 of the MFP 1 illustrated in FIG. 1 functions as a screen display unit 101, a screen touch operation receiving unit 102, a command key operation receiving unit 103, a control unit 104, and a user setting processing unit 105.

The screen display unit 101 acquires a predetermined setting screen from the setting screen information 1001-1 (see FIG. 1) and displays the setting screen on the display unit 14-1 of the operation panel 14 (see FIG. 1). In addition, when a predetermined operation is performed on the displayed setting screen, the screen display unit 101 acquires target screen information from the setting screen information 1001-1, and updates a part or all of the setting screen of the display unit 14-1 based on the screen information. For example, when a touch input using an operation key is performed on the setting screen, the screen display unit 101 acquires screen information corresponding thereto from the setting screen information 1001-1, and updates a part or all of the setting screen of the display unit 14-1.

The screen touch operation receiving unit 102 receives the user's touch operation on the setting screen displayed on the screen display unit 101. Specifically, the touch panel 14-2 (see FIG. 1) detects the position touched by the user on the setting screen displayed on the display unit 14-1 (see FIG. 1), and the screen touch operation receiving unit 102 detects the operation.

When a hardware key included in the command keys 15 (see FIG. 1) is pressed by the user, the command key operation receiving unit 103 receives and executes a command corresponding to the pressed hardware key. For example, when the execution key 15-1 (see FIG. 1) is pressed while the processing of the main body of the MFP 1 is selected, the command key operation receiving unit 103 instructs the control unit 104 to start the above processing. In addition, when the reset key 15-2 (see FIG. 1) or the suspend key 15-3 (see FIG. 1) is pressed after the control unit 104 starts the processing, the command key operation receiving unit 103 instructs the control unit 104 to cancel the processing.

The control unit 104 performs control corresponding to the selected processing. For example, when the execution key 15-1 (see FIG. 1) is pressed while “copy” is selected among the functions of the main body of the MFP 1, the control unit 104 controls the image reading mechanism 17 (see FIG. 1) and the image forming mechanism 16 (see FIG. 1) of the main body of the MFP 1 to start copy processing. Specifically, the control unit 104 first controls the image reading mechanism 17 to read an image to be read, and then controls the image forming mechanism 16 to form the image on a sheet.

The user setting processing unit 105 performs setting of the user setting information 1001-2 (see FIG. 1) and highlight processing based on the information set in the user setting information 1001-2.

Next, a procedure of each processing performed by the CPU 11 (see FIG. 3) of the MFP 1 will be described. When the power is turned on, the CPU 11 performs the functions illustrated in FIG. 3 as described above and receives various types of processing.

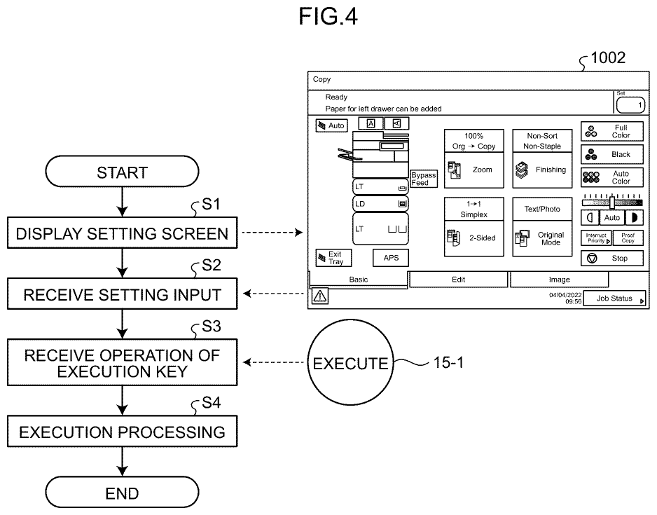

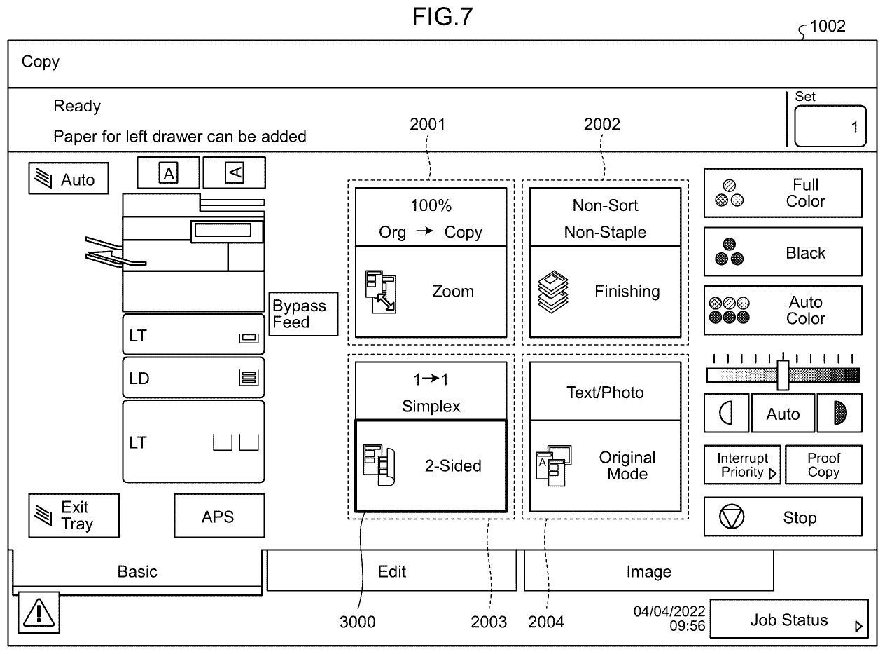

FIG. 4 is a diagram illustrating an example of a schematic procedure of processing of the CPU 11 (see FIG. 3). As an example, a schematic procedure when a user makes copies will be described. When the user selects processing to be used in the MFP 1, the CPU 11 displays a setting screen 1002 for the processing to be used by the user (step S1). Specifically, the CPU 11 displays a selection screen, receives selection of processing to be used in the MFP 1 from the user, and displays the setting screen 1002 for the processing selected by the user (“copy” processing in this example). The setting screen 1002 will be described later in detail with reference to an enlarged view (FIG. 7), and will be briefly described here.

Subsequently, the CPU 11 receives an input of setting on the setting screen 1002 (step S2). The setting screen 1002 is provided with a plurality of setting items. Therefore, the user searches the setting screen 1002 for a setting item that needs to be set among these setting items, and touches and sets the setting item. Each setting item is displayed with an initial value setting. The user touches and sets a setting item that needs to be changed from the initial value.

Subsequently, the CPU 11 receives an operation of the execution key 15-1 (step S3), and starts, when the execution key 15-1 is pressed, copying according to the contents after the setting in step S2, that is, the first setting (step S4).

After starting the copying, the CPU 11 controls the image reading mechanism 17 and the image forming mechanism 16 to execute the copying. When the copying is completed, the CPU 11 terminates the processing and returns to the selection screen for processing to be used.

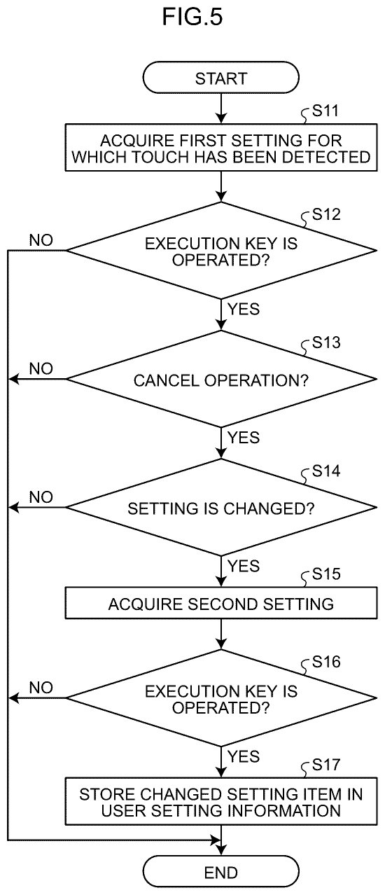

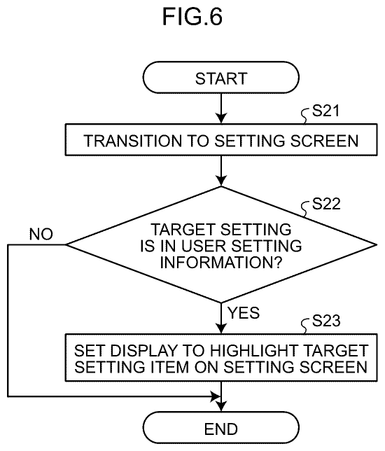

The processing procedures of FIGS. 5 and 6 described next are processing procedures provided to prevent the same mistake from occurring in the next and subsequent times for a setting item that the user has forgotten to set before pressing the execution key 15-1.

As described above, many setting items are provided on the setting screen of the MFP main body. Therefore, a mistake can be made by pressing the execution key 15-1 without setting a setting item, even though the setting of the setting item needs to be changed. If the cause is that a user always forgets to set only the same setting item, the user can repeat the same mistake with the same setting item even in the next and subsequent operations.

Therefore, a setting item for which the mistake has been made can be set in the user setting information 1001-2 (see FIG. 1) with the procedure illustrated in FIG. 5, and the setting item corresponding to a predetermined condition can be highlighted from the next time with the procedure illustrated in FIG. 6. First, the processing procedure in FIG. 5 will be sequentially described.

FIG. 5 is a diagram illustrating an example of a procedure of setting processing for the user setting information 1001-2. This setting processing is performed by the user setting processing unit 105 (see FIG. 3) in the following order.

First, the user setting processing unit 105 acquires the first setting set on the setting screen 1002 (see FIG. 4) (step S11). Since the first setting is performed by the user touching the setting items on the setting screen 1002, the presence or absence of a touch on each setting item provided on the setting screen 1002 is also detected and acquired. The user setting processing unit 105 temporarily stores the first setting in which the setting of each setting item is associated with the presence or absence of a touch in the RAM 12-2 (see FIG. 1).

Subsequently, the user setting processing unit 105 determines an execution key operation, a cancel operation, and a setting change operation in this order (steps S12, S13, and S14). When all the operations in steps S12, S13, and S14 are performed in this order, all of steps S12, S13, and S14 are determined as Yes. In this case, the user setting processing unit 105 acquires the setting of the changed setting item, that is, the second setting (step S15). The user setting processing unit 105 temporarily stores the acquired first setting in the RAM 12-2 (see FIG. 1).

Subsequently, the user setting processing unit 105 determines the presence or absence of the execution key operation after the setting change operation (step S16). When determining that the execution key operation after the setting change operation is “present” (step S16: Yes determination), the user setting processing unit 105 sets and stores the changed setting item in the user setting information 1001-2 (step S17). As an example, the user setting processing unit 105 generates the changed setting item and accompanying information related to the changed setting item, and sets them in association with “user identification information” on the logged-in user who has logged in the MFP 1. In the association in the user setting information 1001-2, information on the changed setting is set in “change”, the flag “1” is set in “change after non-operation” when the setting item to be set in “change” has not been operated in the first setting, and a date or date/time is set in “setting date”.

Note that the information set in “change” by the user setting processing unit 105 is obtained, for example, by the user setting processing unit 105 calculating the difference from a comparison between the first setting and the second setting temporarily stored in the RAM 12-2 (see FIG. 1). In addition, the setting of “change without operation” by the user setting processing unit 105 is set based on the presence or absence of a touch of each setting item temporarily stored in the RAM 12-2 (see FIG. 1) by the user setting processing unit 105, and “1” is set in the case of the absence of a touch.

If No is determined in steps S12, S13, S14, and S16, the processing is terminated, and the data temporarily stored in the RAM 12-2 (see FIG. 1) is discarded.

FIG. 6 is a diagram illustrating an example of a processing procedure that highlights a setting item that the user has forgotten to set in the past. When the screen transitions to the setting screen 1002 (see FIG. 4) after the user logs in to the MFP 1 (step S21), the user setting processing unit 105 (see FIG. 3) determines whether there is a target setting in the user setting information 1001-2 (see FIG. 1) (step S22). For example, the user setting processing unit 105 acquires login information on the logged-in user of the MFP 1. Then, when the setting item of “change” set in association with the corresponding user identification information in the user setting information 1001-2 corresponds to a setting item included in the setting screen 1002, the user setting processing unit 105 determines that there is a target setting (step S22: Yes determination). When there are a plurality of corresponding setting items of “change” and the setting items corresponding to the setting screen 1002 are included therein, all the corresponding setting items are set as target settings. In addition, when the setting item of “change” does not correspond to any of the setting items included in the setting screen 1002, the user setting processing unit 105 determines that there is no target setting (step S22: No determination).

The determination in step S22, including setting the flag in “change after non-operation” in the user setting information 1001-2 may be performed by the user setting processing unit 105. For example, when the flag “1” is set in “change after non-operation” in the setting item of “change” corresponding to the setting item included in the setting screen 1002, the user setting processing unit 105 determines that there is a target setting (Step S22: Yes determination). In this case, the target setting is the setting item set with the flag “1” among the setting items of “change” corresponding to the setting items included in the setting screen 1002. In addition, a determination based on the date of the “setting date” may be added to the determination in step S22. For example, when the elapsed period of time from the date of “setting date” does not exceed a threshold, the user setting processing unit 105 determines that there is a target setting (step S22: Yes determination). In this case, the target setting is the setting item in which the elapsed period of time from the date of the “setting date” does not exceed the threshold among the setting items of “change” corresponding to the setting items included in the setting screen 1002. From this point, the determination may be performed by further narrowing down to the setting items set with the flag “1”.

In addition, if “change after non-operation” is added, the user setting processing unit 105 determines that there is no target setting when there is no flag “1” in “change after non-operation” (step S22: No determination). In addition, if “setting date” is added, it is determined that there is no target setting when the elapsed period of time from the date of “setting date” exceeds the threshold (step S22: No determination).

When determining that there is a target setting (step S22: Yes determination), the user setting processing unit 105 sets the display to highlight the target setting item on the setting screen 1002 (step S23).

After the determination is No in step S22 and after the highlighting is performed in step S23, the processing from step S2 illustrated in FIG. 4 and the procedure illustrated in FIG. 5 are similarly performed.

FIG. 7 is a diagram illustrating an example of a display mode for a setting item on the setting screen 1002. The setting screen 1002 illustrated in FIG. 7 is an example of a copy setting screen. In the setting screen 1002 illustrated in FIG. 7, setting keys for a plurality of setting items are arranged at predetermined positions and displayed on the display unit 14-1. The setting key of each setting item is a software key, an initial value setting is displayed, and when the initial value setting is changed, the changed setting is displayed. Each of a first setting key 2001, a second setting key 2002, a third setting key 2003, and a fourth setting key 2004 is a software key that displays the initial value setting or the changed setting.

Among these setting keys, the third setting key 2003 corresponds to the setting item of “change” in the user setting information 1001-2, and highlight display is set. In this example, a rectangular frame 3000, which is an example of a frame for highlight, is set at the edge of the third setting key 2003. The rectangular frame 3000 may be highlighted with a thick line or a set setting color. Note that the method of highlighting is not limited to this. Since it is sufficient if the user knows that the setting item is a setting item that the user has forgotten to set in the past, the highlighting method may be appropriately modified.

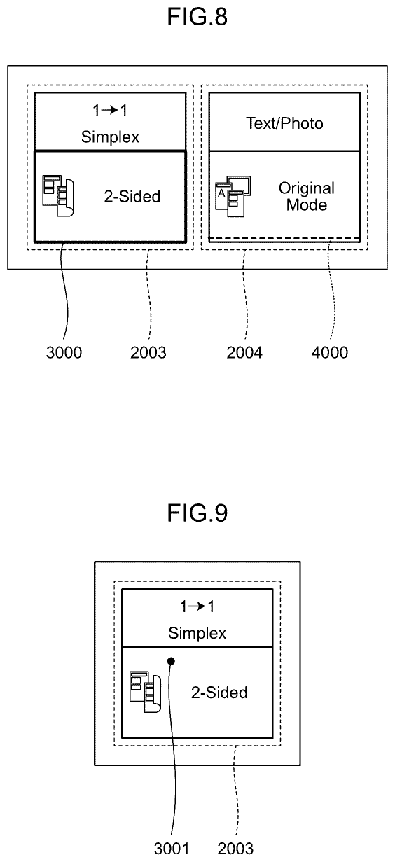

FIG. 8 is a diagram illustrating a first modification of a display mode for a setting item. In the first modification, a display mode for highlighting the display of the setting item is set to a display mode different from a display mode indicating that the setting item has been edited. In FIG. 8, a dotted line 4000 added to the fourth setting key 2004 indicates that the editing has been performed. By setting the third setting key 2003 to the display mode of the rectangular frame 3000 different from the dotted line 4000, the user can visually distinguish the edited setting item and the setting item that the user has forgotten to set in the past.

FIG. 9 is a diagram illustrating a second modification of a display mode for a setting item. The second modification is an example in which a mark 3001 is placed on the third setting key 2003. The mark 3001 may be a circle or another shape. In the second modification, the mark 3001 is attached to highlight the setting item that the user has forgotten to set in the past.

As a third modification, highlighting may be performed as follows. When the setting item that the user has forgotten to set in the past is in a lower-level hierarchy, the user cannot notice the setting item with the display of the higher-level setting screen 1002, even if the setting item is highlighted. Therefore, when the setting item to be highlighted is included in the lower-level hierarchy, the higher-level setting item is also highlighted.

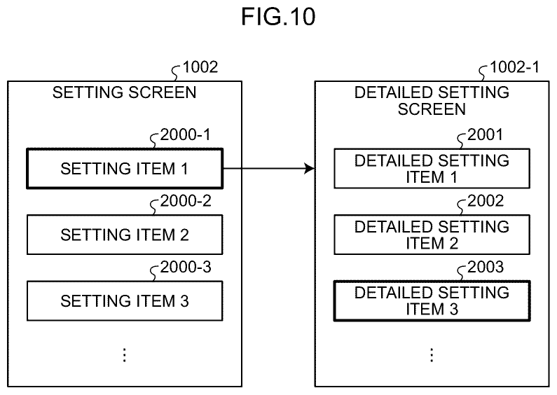

FIG. 10 is a diagram illustrating the third modification of a display mode for a setting item. When there are large number of setting items, information on the setting items can be hierarchized from higher to lower-levels. For example, initially, the major items “setting item 1” 2000-1, “setting item 2” 2000-2, “setting item 3” 2000-3, and so on are displayed on the simple setting screen 1002. Then, when the major item “setting item 1” 2000-1 is selected, the screen transitions to a detailed setting screen 1002-1 to display more detailed “detailed setting item 1” 2001, “detailed setting item 2” 2002, “detailed setting item 3” 2003, and so on.

In the example illustrated in FIG. 10, since the “detailed setting item 3” 2003 is highlighted, the “setting item 1” 2000-1, which is the higher-level setting item, is also highlighted.

As described above, when the setting item in the lower-level hierarchy is highlighted, the setting item in the higher-level hierarchy is also highlighted, and the user can notice that the setting item that the user has forgotten to set in the past is in the lower-level hierarchy.

That is, the third modification includes a higher-level setting screen including a higher-level setting item and a lower-level setting screen including a lower-level setting item corresponding to the higher-level setting item. Then, if the setting item that the user has forgotten to set in the past is the lower-level setting item included in the lower-level setting screen, the display of the higher-level setting item corresponding to the setting item that the user has forgotten to set in the past is also highlighted.

As described above, the MFP 1 according to the present embodiment and each modification visually highlights the setting item that the user has erroneously set in the past on the setting screen on which the user sets the setting item. Among setting errors, in particular, it is possible to visually highlight the setting item that the user has forgotten to set in the past. Therefore, since the setting item that the user has forgotten to set in the past is highlighted on the setting screen, the user can notice the setting item before the execution key is pressed, and it is possible to reduce a mistake that the user has forgotten to set the same setting item.

Note that the description has been given of the purpose of holding a setting item that the user has forgotten to set in the past and highlighting the setting item on the setting screen based on the data on the held setting item. However, if the user has become accustomed to setting the setting item, the highlighting of the setting item may be removed. For example, the highlighting is removed on condition that a predetermined period of time has elapsed or a predetermined number of times the highlighting is performed since the setting item has been set. Specifically, an upper limit value is set for the period of time or the number of times of highlighting, and the setting of highlighting is removed from the setting item when any set value is reached.

In addition, the program to be executed by the MFP 1 according to the embodiment and the modifications may be provided as a file in an installable format or an executable format by being recorded in a computer-readable recording medium, such as a CD-ROM, a flexible disk (FD), a CD-R, or a digital versatile disk (DVD).

In addition, the program to be executed by the MFP 1 according to the embodiment and the modifications may be stored on a computer connected to a network, such as the Internet, and provided by being downloaded via the network. In addition, the program to be executed by the MFP 1 according to the embodiment and the modifications may be provided or distributed via a network such as the Internet.

In addition, the program to be executed by the MFP 1 according to the embodiment and the modifications may be provided by being incorporated in a ROM or the like in advance.

### (Supplementary Note 1)

An image forming apparatus including:
a memory storing a program; and
a processor configured to execute the program stored in the memory to execute processing, in which
the processing includes:
   displaying a setting screen including a plurality of setting items;
   receiving settings of the plurality of setting items,
   starting image forming processing with the settings of the plurality of setting items based on an operation of an execution key;
   after the image forming processing is started, receiving an operation for canceling the image forming processing;
   in a case where the settings are changed after the operation for canceling the image forming processing is received and the image forming processing is started with the changed settings, holding information on a setting item for which the setting before change has been changed; and
   highlighting a display corresponding to the changed setting item on the displayed setting screen.

### (Supplementary Note 2)

The image forming apparatus according to Supplementary Note 1, in which
the information on the held setting item includes information on a setting item for which a change from an initial value has not been received on the setting screen in setting before the operation for canceling the image forming processing has been received, and a change from the initial value has been received after the operation for canceling the image forming processing.

### (Supplementary Note 3)

The image forming apparatus according to Supplementary Note 2, in which
determination of whether the change from an initial value has not been received for the setting item on the setting screen in the settings before the operation for canceling the image forming processing has been received is performed by determining whether a touch has not been detected for the setting item on the setting screen before the operation for canceling the image forming processing has been received.

### (Supplementary Note 4)

The image forming apparatus according to any one of Supplementary Notes 1 to 3, in which
a display mode in a case where the display of the setting item is highlighted on the setting screen is set to a display mode different from a display mode in a case where the setting item has been edited.

### (Supplementary Note 5)

The image forming apparatus according to any one of Supplementary Notes 1 to 3, in which
a frame of the changed setting item is highlighted with a thick line or a set color.

### (Supplementary Note 6)

The image forming apparatus according to any one of Supplementary Notes 1 to 3, in which
the changed setting item is highlighted by placing a mark.

### (Supplementary Note 7)

The image forming apparatus according to any one of Supplementary Notes 1 to 6, in which
the setting screen includes:
   a higher-level setting screen including a higher-level setting item; and
   a lower-level setting screen including a lower-level setting item corresponding to the higher-level setting item, and
in a case where the changed setting item is the lower-level setting item included in the lower-level setting screen, a display of the higher-level setting item corresponding to the changed setting item is also highlighted.

### (Supplementary Note 8)

The image forming apparatus according to any one of Supplementary Notes 1 to 7, in which
the processing further includes:
   holding user information and the changed setting item in association with each other, and
   highlighting a display corresponding to the changed setting item held in association with the user information of a user who sets the setting screen.

### (Supplementary Note 9)

The image forming apparatus according to any one of Supplementary Notes 1 to 8, in which
the processing further includes removing the highlighting corresponding to the changed setting item on condition that a predetermined period of time has elapsed or a predetermined number of times the highlighting has been performed since the changed setting item has been set.

### (Supplementary Note 10)

A display method of a setting screen of an image forming apparatus, the display method including steps of:
displaying, by the image forming apparatus, a setting screen including a plurality of setting items;
receiving, by the image forming apparatus, settings of the plurality of setting items;
starting, by the image forming apparatus, image forming processing with the settings of the plurality of setting items based on an operation of an execution key;
after the starting the image forming processing receiving, by the image forming apparatus, an operation for canceling the image forming processing;
in a case where the settings are changed after the operation for canceling the image forming processing is received and the image forming processing is started with the changed settings, holding, by the image forming apparatus, information on a setting item for which the setting before the change has been changed; and
highlighting, by the image forming apparatus, a display corresponding to the changed setting item on the displayed setting screen.

### (Supplementary Note 11)

The display method according to Supplementary Note 10, in which
the information on the held setting item comprises information on a setting item for which a change from an initial value has not been received on the setting screen in setting before the operation for canceling the image forming processing has been received, and a change from the initial value has been received after the operation for canceling the image forming processing.

### (Supplementary Note 12)

The display method according to Supplementary Note 11, in which
determination of whether the change from an initial value has not been received for the setting item on the setting screen in the settings before the operation for canceling the image forming processing has been received is performed by determining whether a touch has not been detected for the setting item on the setting screen before the operation for canceling the image forming processing has been received.

### (Supplementary Note 13)

The display method according to any one of Supplementary Notes 10 to 12, in which
a display mode in a case where the display of the setting item is highlighted on the setting screen is set to a display mode different from a display mode in a case where the setting item has been edited.

### (Supplementary Note 14)

The display method according to any one of Supplementary Notes 10 to 12, in which
a frame of the changed setting item is highlighted with a thick line or a set color.

### (Supplementary Note 15)

The display method according to any one of Supplementary Notes 10 to 12, in which
the changed setting item is highlighted by placing a mark.

### (Supplementary Note 16)

The display method according to any one of supplementary Notes 10 to 15, in which
the setting screen comprises:
   a higher-level setting screen including a higher-level setting item; and
   a lower-level setting screen including a lower-level setting item corresponding to the higher-level setting item, and
in a case where the changed setting item is the lower-level setting item included in the lower-level setting screen, a display of the higher-level setting item corresponding to the changed setting item is also highlighted.

### (Supplementary Note 17)

The display method according to any one of supplementary Notes 10 to 16, further including
holding user information and the changed setting item in association with each other, and
highlighting a display corresponding to the changed setting item held in association with the user information of a user who sets the setting screen.

### (Supplementary Note 18)

The display method according to any one of supplementary Notes 10 to 17, further comprises
removing the highlighting corresponding to the changed setting item on condition that a predetermined period of time has elapsed or a predetermined number of times the highlighting has been performed since the changed setting item has been set.

### (Supplementary Note 19)

A program causing a computer of an image forming apparatus to execute processing of:
displaying a setting screen including a plurality of setting items;
receiving settings of the plurality of setting items,
starting image forming processing with the settings of the plurality of setting items based on an operation of an execution key;
after the image forming processing is started, receiving an operation for canceling the image forming processing;
in a case where the settings are changed after the operation for canceling the image forming processing is received and the image forming processing is started with the changed settings, holding information on a setting item for which the setting before change has been changed; and highlighting a display corresponding to the changed setting item on the displayed setting screen.

### (Supplementary Note 20)

The program according to Supplementary Note 19, in which
the information on the held setting item includes information on a setting item for which a change from an initial value has not been received on the setting screen in setting before the operation for canceling the image forming processing has been received, and a change from the initial value has been received after the operation for canceling the image forming processing.

The above-described embodiments are illustrative and do not limit the present invention. Thus, numerous additional modifications and variations are possible in light of the above teachings. For example, at least one element of different illustrative and exemplary embodiments herein may be combined with each other or substituted for each other within the scope of this disclosure and appended claims. Further, features of components of the embodiments, such as the number, the position, and the shape are not limited the embodiments and thus may be preferably set. It is therefore to be understood that within the scope of the appended claims, the disclosure of the present invention may be practiced otherwise than as specifically described herein.

The method steps, processes, or operations described herein are not to be construed as necessarily requiring their performance in the particular order discussed or illustrated, unless specifically identified as an order of performance or clearly identified through the context. It is also to be understood that additional or alternative steps may be employed.

Further, any of the above-described apparatus, devices or units can be implemented as a hardware apparatus, such as a special-purpose circuit or device, or as a hardware/software combination, such as a processor executing a software program.

Further, as described above, any one of the above-described and other methods of the present invention may be embodied in the form of a computer program stored in any kind of storage medium. Examples of storage mediums include, but are not limited to, flexible disk, hard disk, optical discs, magneto-optical discs, magnetic tapes, nonvolatile memory, semiconductor memory, read-only-memory (ROM), etc.

Alternatively, any one of the above-described and other methods of the present invention may be implemented by an application specific integrated circuit (ASIC), a digital signal processor (DSP) or a field programmable gate array (FPGA), prepared by interconnecting an appropriate network of conventional component circuits or by a combination thereof with one or more conventional general purpose microprocessors or signal processors programmed accordingly.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), digital signal processor (DSP), field programmable gate array (FPGA) and conventional circuit components arranged to perform the recited functions.

What is claimed is:

1. An image forming apparatus comprising:
a memory storing a program; and
a processor configured to execute the program stored in the memory to execute processing, wherein
the processing comprises:
displaying a setting screen including a plurality of setting items;
receiving settings of the plurality of setting items;
starting image forming processing with the settings of the plurality of setting items based on an operation of an execution key;
after the image forming processing is started, receiving an operation for canceling the image forming processing;
in a case where the settings are changed after the operation for canceling the image forming processing is received and the image forming processing is started with the changed settings, holding information on a setting item for which the setting before change has been changed; and
highlighting a display corresponding to the changed setting item on the displayed setting screen.

2. The image forming apparatus according to claim 1, wherein
the information on the held setting item comprises information on a setting item for which a change from an initial value has not been received on the setting screen in setting before the operation for canceling the image forming processing has been received, and a change from the initial value has been received after the operation for canceling the image forming processing.

3. The image forming apparatus according to claim 2, wherein
determination of whether the change from an initial value has not been received for the setting item on the setting screen in the settings before the operation for canceling the image forming processing has been received is performed by determining whether a touch has not been detected for the setting item on the setting screen before the operation for canceling the image forming processing has been received.

4. The image forming apparatus according to claim 1, wherein
a display mode in a case where the display of the setting item is highlighted on the setting screen is set to a display mode different from a display mode in a case where the setting item has been edited.

5. The image forming apparatus according to claim 1, wherein
a frame of the changed setting item is highlighted with a thick line or a set color.

6. The image forming apparatus according to claim 1, wherein
the changed setting item is highlighted by placing a mark.

7. The image forming apparatus according to claim 1, wherein
the setting screen comprises:
a higher-level setting screen including a higher-level setting item; and
a lower-level setting screen including a lower-level setting item corresponding to the higher-level setting item, and
in a case where the changed setting item is the lower-level setting item included in the lower-level setting screen, a display of the higher-level setting item corresponding to the changed setting item is also highlighted.

8. The image forming apparatus according to claim 4, wherein
the setting screen comprises:
a higher-level setting screen including a higher-level setting item; and
a lower-level setting screen including a lower-level setting item corresponding to the higher-level setting item, and
in a case where the changed setting item is the lower-level setting item included in the lower-level setting screen, a display of the higher-level setting item corresponding to the changed setting item is also highlighted.

9. The image forming apparatus according to claim 5, wherein
the setting screen comprises:
a higher-level setting screen including a higher-level setting item; and
a lower-level setting screen including a lower-level setting item corresponding to the higher-level setting item, and
in a case where the changed setting item is the lower-level setting item included in the lower-level setting screen, a display of the higher-level setting item corresponding to the changed setting item is also highlighted.

10. The image forming apparatus according to claim 6, wherein
the setting screen comprises:
a higher-level setting screen including a higher-level setting item; and
a lower-level setting screen including a lower-level setting item corresponding to the higher-level setting item, and
in a case where the changed setting item is the lower-level setting item included in the lower-level setting screen, a display of the higher-level setting item corresponding to the changed setting item is also highlighted.

11. The image forming apparatus according to claim 1, wherein
the processing further comprises:
holding user information and the changed setting item in association with each other, and
highlighting a display corresponding to the changed setting item held in association with the user information of a user who sets the setting screen.

12. The image forming apparatus according to claim 4, wherein
the processing further comprises:
holding user information and the changed setting item in association with each other, and
highlighting a display corresponding to the changed setting item held in association with the user information of a user who sets the setting screen.

13. The image forming apparatus according to claim 5, wherein
the processing further comprises:
holding user information and the changed setting item in association with each other, and
highlighting a display corresponding to the changed setting item held in association with the user information of a user who sets the setting screen.

14. The image forming apparatus according to claim 6, wherein
the processing further comprises:
holding user information and the changed setting item in association with each other, and
highlighting a display corresponding to the changed setting item held in association with the user information of a user who sets the setting screen.

15. The image forming apparatus according to claim 7, wherein
the processing further comprises:
holding user information and the changed setting item in association with each other, and
highlighting a display corresponding to the changed setting item held in association with the user information of a user who sets the setting screen.

16. The image forming apparatus according to claim 11, wherein
the processing further comprises:
holding user information and the changed setting item in association with each other, and
highlighting a display corresponding to the changed setting item held in association with the user information of a user who sets the setting screen.

17. The image forming apparatus according to claim 1, wherein
the processing further comprises removing the highlighting corresponding to the changed setting item on condition that a predetermined period of time has elapsed or a predetermined number of times the highlighting has been performed since the changed setting item has been set.

18. The image forming apparatus according to claim 7, wherein
the processing further comprises removing the highlighting corresponding to the changed setting item on condition that a predetermined period of time has elapsed or a predetermined number of times the highlighting has been performed since the changed setting item has been set.

19. A computer-readable storage medium storing a program, the program causing a computer of an image forming apparatus to execute processing of:
displaying a setting screen including a plurality of setting items;
receiving settings of the plurality of setting items,
starting image forming processing with the settings of the plurality of setting items based on an operation of an execution key;
after the image forming processing is started, receiving an operation for canceling the image forming processing;
in a case where the settings are changed after the operation for canceling the image forming processing is received and the image forming processing is started with the changed settings, holding information on a setting item for which the setting before change has been changed; and
highlighting a display corresponding to the changed setting item on the displayed setting screen.

20. The computer-readable storage medium according to claim 19, wherein
the information on the held setting item comprises information on a setting item for which a change from an initial value has not been received on the setting screen in setting before the operation for canceling the image forming processing has been received, and a change from the initial value has been received after the operation for canceling the image forming processing.
